(19) United States
(12) Patent Application Publication
(10) Pub. No.: US 2025/0062678 A1
(43) Pub. Date: Feb. 20, 2025

(54) CURRENT LIMIT FOR MULTIPHASE POWER CONVERTERS

(71) Applicant: Texas Instruments Incorporated, Dallas, TX (US)

(72) Inventors: Ramakrishnan Venkatraman, BENGALURU (IN); Vikram Gakhar, BANGALORE (IN); Nischal R, CHIKKABALLAPUR (IN); Amrutheshwara Rao KV, BANGALORE (IN); Madhura Nasare, MUMBAI (IN); Naman Bafna, BALAGHAT (IN)

(21) Appl. No.: 18/425,138

(22) Filed: Jan. 29, 2024

(30) Foreign Application Priority Data
Aug. 17, 2023 (IN) 202341055113

(51) Int. Cl. H02M 1/088; H02M 3/158

(52) U.S. Cl. CPC H02M 1/088; H02M 3/1584

(57) ABSTRACT

Described embodiments include a control circuit with a first comparator having a first comparator input receiving a first threshold voltage, and a second comparator input coupled to an output voltage terminal. A second comparator has a third comparator input receiving a second threshold voltage, and a fourth comparator input coupled to a current output terminal. A first logic circuit provides a true signal at its output responsive to a particular number of its inputs receiving a true input. A second logic circuit has inputs coupled to the first comparator output, and to the first logic output. A variable resistance circuit has an output coupled to a mode detection output. An amplifier has inputs coupled to the variable resistance circuit output, and a third reference voltage source. A duty cycle generation circuit provides a respective pulse width modulation (PWM) signal at each of its respective duty cycle outputs.

### BACKGROUND

This description relates to current limiting circuits for multi-phase power converters, particularly for multi-phase converters such as those used in servers, personal computers, and communication equipment such as switchers and routers. The control loop for a constant ON time multi-phase controller with valley mode current limiting can become unstable in current limit mode when used with a typical trans-inductor voltage regulator (TLVR) power network.

TLVR power networks may have non-monotonic phase currents that can create a positive feedback in the timing of the PWM pulses. The positive feedback may cause the PWM pulses from the different phases to alternately bunch up and spread out in controllers for TLVR power networks that use valley mode current limiting. The bunching up of PWM pulses can cause a significant increase in voltage ripple on the output voltage. Because it is a positive feedback cycle, this continues until it reaches a steady state with a large inductor current ripple.

### SUMMARY

In a first example, a control circuit includes a first comparator having first and second comparator inputs and a first comparator output. The first comparator input is coupled to a first reference voltage source that provides a first threshold voltage, and the second comparator input is coupled to an output voltage terminal. A second comparator has third and fourth comparator inputs and a second comparator output. The third comparator input is coupled to a second reference voltage source that provides a second threshold voltage, and the fourth comparator input is coupled to a current output terminal.

A first logic circuit has N logic inputs and a first logic output. A first logic input of the N logic inputs is coupled to the second comparator output. The first logic circuit is configured to provide a true logic signal at the first logic output in response to a particular number of the respective N logic inputs receiving a true logic input. A second logic circuit has first and second mode detection inputs and a mode detection output. The first mode detection input is coupled to the first comparator output, and the second mode detection input is coupled to the first logic output.

A variable resistance circuit has first and second variable resistance inputs and a variable resistance output. The first variable resistance input is coupled to the mode detection output. An amplifier has first and second amplifier inputs and an amplifier output. The first amplifier input is coupled to the variable resistance output, and the second amplifier input is coupled to a third reference voltage source that provides a reference voltage. A duty cycle generation circuit has a duty cycle input and N duty cycle outputs. The duty cycle generation circuit is configured to provide a respective pulse width modulation (PWM) signal at each respective duty cycle output.

In a second example, a voltage converter circuit includes N power stage circuits and a controller circuit. Each respective power stage circuit includes a respective high-side transistor and a respective low-side transistor that are connected in series at a respective switching terminal. The controller circuit includes a first comparator having first and second comparator inputs and a first comparator output. The first comparator input is coupled to a first reference voltage source that provides a first threshold voltage, and the second comparator input is coupled to an output voltage terminal. A second comparator has third and fourth comparator inputs and a second comparator output. The third comparator input is coupled to a second reference voltage source that provides a second threshold voltage, and the fourth comparator input is coupled to a current output terminal.

A first logic circuit has N logic inputs and a first logic output. A first logic input of the N logic inputs is coupled to the second comparator output. The first logic circuit is configured to provide a true logic signal at the first logic output in response to a particular number of the respective N logic inputs receiving a true logic input. A second logic circuit has first and second mode detection inputs and a mode detection output. The first mode detection input is coupled to the first comparator output, and the second mode detection input is coupled to the first logic output.

A variable resistance circuit has first and second variable resistance inputs and a variable resistance output. The first variable resistance input is coupled to the mode detection output. An amplifier has first and second amplifier inputs and an amplifier output. The first amplifier input is coupled to the variable resistance output, and the second amplifier input is coupled to a third reference voltage source that provides a reference voltage. A duty cycle generation circuit has a duty cycle input and N duty cycle outputs. The duty cycle generation circuit is configured to provide a respective pulse width modulation (PWM) signal at each respective duty cycle output.

### BRIEF DESCRIPTION OF THE DRAWINGS

FIG. 1 shows a block diagram for an example traditional multiphase voltage converter.

FIG. 2 shows a schematic diagram for an example multiphase trans-inductor voltage converter.

FIG. 3 shows a timing diagram for an example trans-inductor multiphase voltage converter with current limiting.

FIG. 4 shows a schematic diagram for an example controller for a TLVR voltage converter with current limiting.

### DETAILED DESCRIPTION

In this description, the same reference numbers depict same or similar (by function and/or structure) features. The drawings are not necessarily drawn to scale.

A voltage regulator receives an input voltage at an input voltage terminal and regulates that voltage to a specified output voltage level, then provides the regulated voltage at an output voltage terminal. In a multiphase voltage regulator, each phase usually includes a high-side field effect transistor (FET), a low-side FET, and an inductor. The respective outputs of all the phases are connected together to provide current to a load at the specified output voltage. Each phase of the multiphase voltage regulator delivers current to the same output capacitor to filter the output voltage.

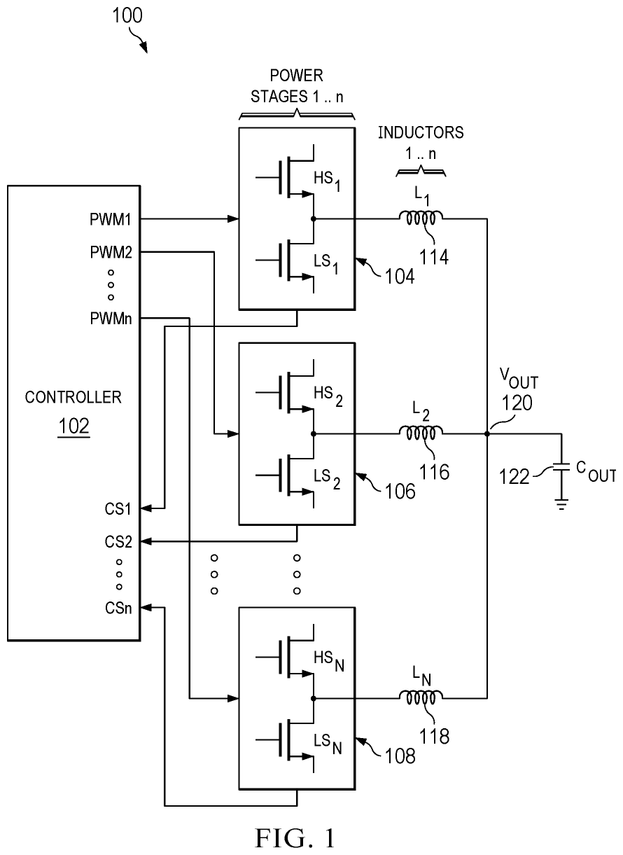

FIG. 1 shows a block diagram for an example traditional multiphase voltage converter 100. Controller 102 has N output terminals, where N is the number of phases in multiphase voltage converter 100. Each of the N outputs of controller 102 (e.g. PWM1, PWM2, etc.) corresponds to a respective phase of multiphase voltage converter 100. Each phase of multiphase voltage converter 100 has a respective power stage that includes a high-side transistor and a low-side transistor that are connected in series at a respective switching terminal.

The power stage 104 for phase 1 includes high-side transistor HS₁ and low-side transistor LS₁. The power stage 106 for phase 2 includes high-side transistor HS₂ and low-side transistor LS₂. The power stage 108 for phase N includes high-side transistor HS_{N} and low-side transistor LS_{N}. Each phase of multiphase voltage converter 100 has a respective output inductor having a first terminal coupled to the switching terminal that connects the high-side transistor and low-side transistor of that respective phase. Inductor L₁ 114 is the output inductor for phase 1, and is coupled to power stage 104. Inductor L₂ 116 is the output inductor for phase 2, and is coupled to power stage 106. Inductor L_{N} 118 is the output inductor for phase N, and is coupled to power stage 108.

The second terminals of each of the N inductors (e.g. 114, 116, 118) are each coupled to the output voltage terminal V_{OUT} 120 and provides current from its respective phase. The current from all the phases is summed together and provided as an output current at the output voltage terminal V_{OUT} 120. An output capacitor C_{OUT} 122 is coupled between the output voltage terminal V_{OUT} 120 and a ground terminal. The output current summed from all of the phases of multiphase voltage converter 100 is filtered by output capacitor C_{OUT} 122.

The controller 102 for multiphase voltage converter 100 provides control signals to each of the respective phases in a phase-interleaved manner (e.g. 90 degrees apart for four phases). For high current demands, it can be impractical from a cost and space standpoint to have a single large pair of high-side and low-side FETs and a single large inductor to deliver all the current. So, the current load is distributed over multiple phases, wherein each phase supplies a portion of the total output current.

For example, in at least one case, the number of phases chosen to supply sufficient current to power a processor is eight phases. However, transient current demands may occur in which the processor requires more current than the number of phases in the multiphase voltage converter can supply. In these cases, a workaround may be used to supply the necessary current without damaging the components of the voltage converter. One such potential workaround is to implement a burst mode in which the current draw from the voltage converter is allowed to operate at its current limit specification for a period of time (e.g. hundreds of nanoseconds) that is short enough to avoid damaging components in the system, then subsequently reduces the current demand to below the current limit.

During the time that multiphase voltage converter 100 is operating in the burst mode, the controller 102 limits the output current below the demand level because the demanded output current exceeds the maximum current that the converter is specified to supply. During the time the output current is being limited, the load is demanding more current than is being delivered by multiphase voltage converter 100. To make up the difference between the demanded current and the current that the voltage converter can supply, the output capacitor C_{OUT} 122 begins supplying additional current. The voltage across output capacitor C_{OUT} 122 discharges at a constant rate as the capacitor supplies current.

In response to determining that the output voltage has fallen below a certain threshold, the system may throttle back its current demand and initiate burst mode operation in multiphase voltage converter 100. In burst mode, the system temporarily takes more current than the multiphase voltage converter 100 can supply. The voltage regulator operates in current limiting mode, and the output capacitor discharges to provide the additional current to supply to the load.

Trans-inductor voltage regulators (TLVRs) have replaced traditional buck voltage regulators in some cases due to the advantages that they can bring. The TLVR differs from a traditional voltage regulator in that the output inductors are replaced by output transformers. So, instead of respective output inductors supplying the current to the output capacitor, each phase of the multiphase voltage converter has a respective transformer coupled to the output capacitor. The primary side of the transformer is connected similarly to how the inductor is connected in a traditional buck regulator. The output transformer is coupled between the switching terminal for its respective phase and the output voltage terminal.

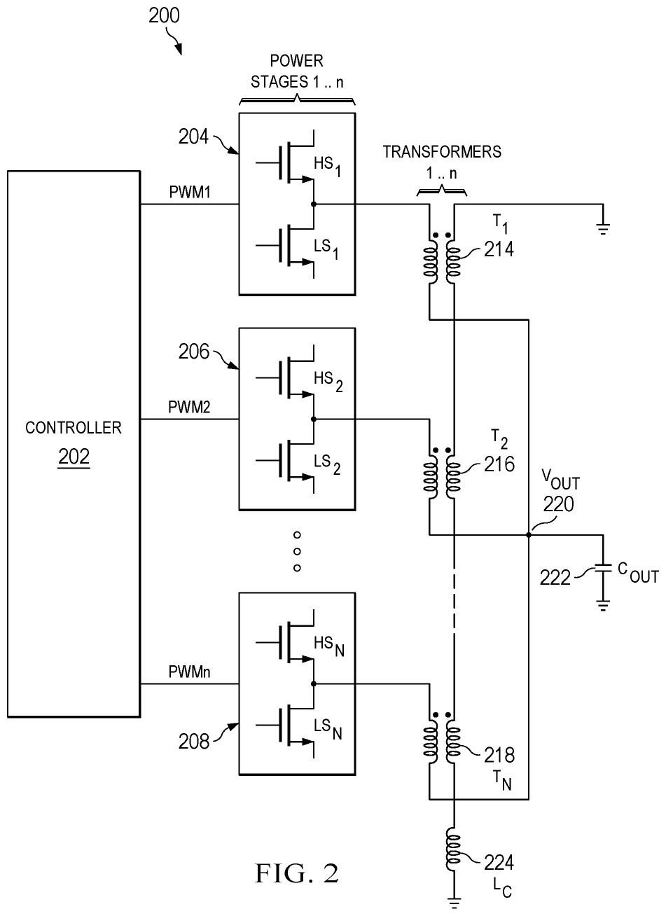

FIG. 2 shows a block diagram for an example multiphase trans-inductor voltage converter 200. Controller 202 has N output terminals, where N is the number of phases in multiphase voltage converter 200. Each of the N outputs of controller 202 (e.g. PWM1, PWM2, etc.) corresponds to a respective phase of multiphase voltage converter 200. Each phase of multiphase voltage converter 200 has a respective power stage that includes a high-side transistor and a low-side transistor connected in series at a respective switching terminal.

The power stage 204 for phase 1 includes high-side transistor HS₁ and low-side transistor LS₁. The power stage 206 for phase 2 includes high-side transistor HS₂ and low-side transistor LS₂. The power stage 208 for phase N includes high-side transistor HS_{N} and low-side transistor LS_{N}. Each phase of multiphase voltage converter 200 has a respective output transformer having a primary and a secondary. The primary of each respective transformer in multiphase trans-inductor voltage converter 200 is connected in a manner similar to each respective inductor in multiphase voltage converter 100.

The primary of each respective transformer in multiphase voltage converter 200 has a first terminal coupled to the switching terminal that connects the high-side transistor and low-side transistor for that respective phase. Transformer T₁ 214 is the output transformer for phase 1, and is coupled to the switching terminal for power stage 204. Transformer T₂ 216 is the output transformer for phase 2, and is coupled to the switching terminal for power stage 206. Transformer T_{N} 218 is the output transformer for phase N, and is coupled to the switching terminal for power stage 208.

The second terminals of each primary of the N transformers (e.g. 214, 216, 218) are each coupled to the output voltage terminal V_{OUT} 220 and provides current from its respective phase. The current from all the phases is summed together and provided as the output current at the output voltage terminal V_{OUT} 220. An output capacitor C_{OUT} 222 is coupled between the output voltage terminal V_{OUT} 220 and a ground terminal. The summed current from all of the phases of multiphase trans-inductor voltage converter 200 is filtered by output capacitor C_{OUT} 222.

The secondary of each of the transformers in all of the phases are connected in series, with the second terminal of each respective transformer connected to the first terminal of the next transformer in the series. The first terminal of transformer T₁ 214 is coupled to the ground terminal. The second terminal of transformer T_{N} is coupled to a first terminal of a compensating inductor, L_{C} 224. The second terminal of the compensating inductor L_{C} 224 is connected to the ground terminal. Therefore, the second terminal of the compensating inductor L_{C} 224 is connected to the first terminal of transformer T₁ 214. So, all of the secondaries are connected together in a single loop that includes compensating inductor L_{C} 224.

If a load transient occurs and the controller 202 increases the duty cycle of its output for one of the phases, the current for that phase increases. The increase in the primary current in a phase causes the secondary current in that respective phase to increase. The secondary current in all the phases increases when the current in any respective phase increases because the secondaries of all the phases are connected together in a single loop.

As the current in the secondary of each respective transformer increases, that secondary current is reflected to the primary side of the transformer in each respective phase. Because the secondaries of all the transformers are connected together, that secondary current is reflected to each respective primary in all of the phases. So, a current increase in the secondary of any transformer increases the current in the primaries of the transformers in all the phases, not just the phase that the controller increased the duty cycle.

A duty cycle change has a multiplying effect on how fast the current ramps up. Increasing the duty cycle significantly increases the gain of the loop, and improves the transient response of a TLVR voltage converter. Also, less output capacitance is required with the TLVR converter compared to the traditional regulator, thus saving costs. That is a significant advantage that has led to a significant increase in TLVR voltage converters compared to traditional multiphase voltage converters. However, the loop dynamics of a TLVR voltage converter are different from traditional multiphase voltage converter loop dynamics, and can become unstable.

When operating in burst mode rather than in voltage regulation mode, the TLVR voltage converter can cause the loop to become unstable and to have increased voltage ripple on the output voltage at the output voltage terminal V_{OUT} 220 due to the magnitudes of both the current and the voltage at the output voltage terminal V_{OUT} 220 going up and down. This may lead to violation of the system undershoot voltage specification while operating in burst mode. This can occur because the current is dominated by the secondary loop. The same amount of current flows through each of the transformer secondaries for all the phases because the secondaries of all the transformers are connected together in series forming a single loop. So, the current waveforms of the different phases do not differ as much as they otherwise would in a traditional multiphase voltage converter because the secondary current component is identical for each of the phases.

Because there is an insignificant differentiation between the currents of each of the phases, the control loop can become confused because the phases look identical and cannot be distinguished from one another. When the loop tries to increase the current in a single phase, the currents in all the phases increase. When the loop tries to decrease the current in a single phase, the currents in all the phases decrease. So, the loop is not able to properly interleave the pulses of each of the phases. This causes the regulator to continually go in and out of current limit because more current is being demanded, but the voltage converter is already over the current limit, so it cuts the current back. However, the demand for more current is still there, so the cycle repeats, creating an instability.

This is why constant ON-time multiphase controllers with valley mode current limiting can become unstable in current limit mode when used with a TLVR power network. The non-monotonic phase currents create a positive feedback in the timing of the PWM pulses. This positive feedback causes the PWM pulses from the different phases to alternately bunch up and spread out.

When operating in burst mode, the load draws more current than the current limit of the TLVR controller allows. The controller continually operates in current limit mode for a period of time, and the difference between the load current and the current limit is supplied by the output capacitor. The output voltage will gradually decrease with time. Instability in the current limiting behaviour during this mode can cause high ripple and violation of the voltage accuracy specification.

A potential solution for this instability problem is to gradually increase the load line resistance of the controller as soon as the system enters burst mode operation. Load line resistance is a parameter of the system that is defined as the slope of the output voltage versus the load current. An increase in the load line resistance causes the output voltage to decrease linearly, forcing a portion of the load current to be supplied by another source, which in this case is the output capacitor.

If the load line resistance is chosen properly, enough current is diverted from the controller to the output capacitor that the current supplied by the controller falls below the current limit. As long as the current supplied by the controller is below the current limit, the controller operates in the voltage regulation mode rather than the current limiting mode. When operating in the voltage regulation mode, the loop is stable, and the instability that can occur operating in current limit mode from a TLVR network having constant ON-time multiphase controllers with valley mode current limiting does not occur.

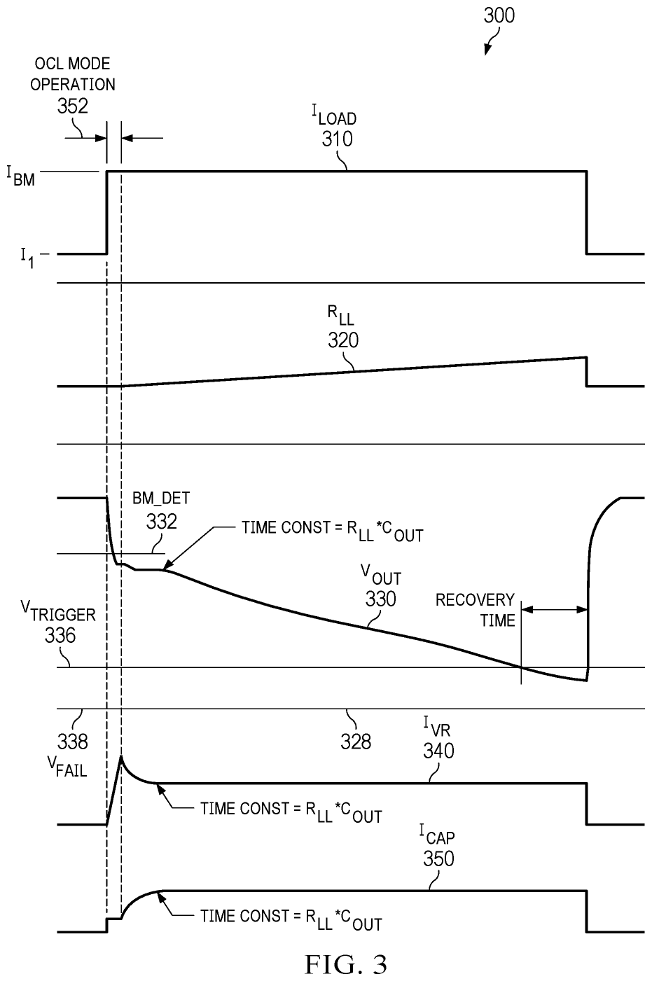

FIG. 3 shows a timing diagram 300 for an example TLVR system with current limiting. Curve 310 is a graph of load current I_{LOAD} versus time. The load current I_{LOAD} varies between a first current level I₁ and a second current level I_{BM}, which is the load current provided by the voltage regulator while operating in burst mode. Curve 320 is a graph of the load line resistance R_{LL} versus time. Load line resistance is a parameter of the system, and is defined as the slope of the output voltage V_{OUT} 330 versus load current I_{LOAD} 310.

Curve 330 is a graph of the multimode voltage regulator output voltage V_{OUT} versus time. Curve 340 is a graph of the current output of the voltage regulator. Curve 350 is a graph of the current provided by the output capacitor C_{OUT}. The load current I_{LOAD} 310 is equal to the sum of the current output of the voltage regulator and the current provided by the output capacitor C_{OUT}.

In curve 310, the load current I_{LOAD} 310 increases rapidly, which causes the output voltage V_{OUT} 330 to decrease. In response to the output voltage V_{OUT} 330 crossing a particular voltage threshold, BM_DET 332, the multimode voltage regulator switches to burst mode operation, which means operating in current limiting mode, not voltage regulation mode. Many applications operate at a particular load line resistance, which means that as the load current I_{LOAD} 310 increases, the output voltage V_{OUT} 330 decreases linearly with the load current. At no load, the output voltage V_{OUT} 330 is equal to a reference voltage. As the load current I_{LOAD} 310 increases, the multimode voltage converter provides a linearly decreasing voltage at the output voltage V_{OUT} 330.

In response to detecting that the load current I_{LOAD} 310 has increased and the output voltage V_{OUT} 330 has crossed the voltage threshold BM_DET 332, it is determined that the system has switched to operating in burst mode, and the controller increases the load line resistance R_{LL} 320. As the load line resistance R_{LL} 320 increases, the output voltage V_{OUT} 330 will decrease even though the load current I_{LOAD} 310 remains constant because it is the controller that is regulating the load line resistance R_{LL} 320. The output voltage will be regulated to a voltage that is equal to the reference voltage minus the product of the load current I_{LOAD} 310 and the load line resistance R_{LL} 320.

So, as the load line resistance R_{LL} 320 increases, the output voltage V_{OUT} 330 decreases. This simulates the gradual decrease of output voltage as a function of current, which would otherwise happen if the current was being regulated. The load line resistance R_{LL} 320 is increasing and causing the output voltage V_{OUT} 330 to decrease at a slope that is proportional to the rate of discharge of the output capacitor C_{OUT}.

During burst mode operation, the voltage regulation loop is operating, not a current limit loop. However, the voltage regulation loop is regulating the output voltage V_{OUT} 330 to a lower voltage as the load line resistance R_{LL} 320 is being increased. The voltage loop is stable, and does not have the instability problem that can occur in a TLVR voltage regulator with constant ON-time multiphase controllers with valley mode current limiting while operating in a current limit mode. The instability problems are avoided because the TLVR voltage regulator is not operating in current limiting mode.

There are two criteria to trigger the start of increasing the load line resistance R_{LL}. If both are true, the system will transition to burst mode, and the load line resistance R_{LL} is increased. Those two criteria are: (1) that the output voltage falls below BM_DET; and (2) that the loop is limiting the load current for a particular time. The way the regulator limits the current is to stop giving pulses for a while. The current is limited by stopping pulses on the PWM lines controlling the power stages (PWM₁, PWM₂ . . . PWM_{N}). At low loads, the current is not being limited, so the BM_DET signal will be low. As the current increases, it may reach the current limit of the voltage converter. When that happens, the loop operates in current limit mode. If the loop operates in current limit mode for a specified amount of time, and the voltage at the output voltage terminal V_{OUT} drops below the BM_DET threshold, the system transitions to operating in burst mode, and the load line resistance R_{LL} is increased.

Because the load line resistance R_{LL} is increased, the voltage at the output voltage terminal V_{OUT} starts decreasing, which means that some current is being supplied by the output capacitor C_{OUT}. As long as there is a non-zero slope in the output voltage, some current is being supplied by the output capacitor C_{OUT}, and that current is proportional to the slope of the output voltage versus load current. When current is being supplied by the output capacitor C_{OUT}, the current from the voltage regulator is less than the load current by the amount that the output capacitor C_{OUT} is supplying. This is a way of decreasing the output current and preventing it from operating in current limiting mode. Because it is not operating in current limiting mode, it is operating in voltage regulation mode which does not have the same stability and output voltage ripple issues as in current limiting mode.

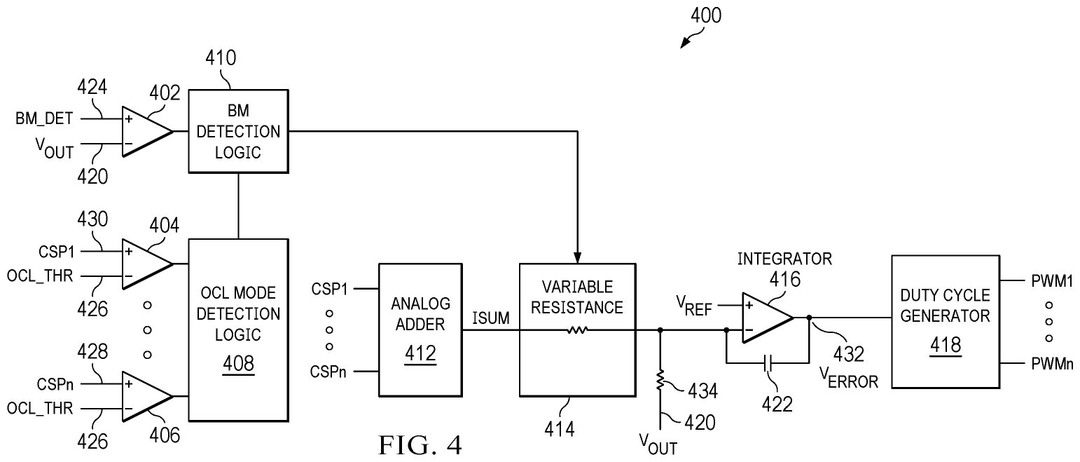

FIG. 4 shows a schematic diagram for an example controller 400 for a TLVR voltage converter with current limiting. Comparator 402 has a first input coupled to a burst mode reference voltage circuit and receives a signal BM_DET 424 that indicates a threshold voltage for the system to enter burst mode operation. A second input to comparator 402 is coupled to the output voltage terminal V_{OUT} 420. Comparator 402 compares the voltage at the output voltage terminal V_{OUT} 420 to the threshold voltage for the system to transition to burst mode operation, and provides a high signal at its output if the output voltage at the output voltage terminal V_{OUT} 420 drops below BM_DET 424.

There are N phase current comparators, each comparator corresponding to a respective phase of a multiphase voltage converter. Each of the phase current comparators compares the current being provided by its respective phase to a current limit threshold OCL_THR 426. If any of the N phase currents is higher than the current limit threshold OCL_THR 426, the phase current comparator for that respective phase will provide a high or “true” signal at its output.

Comparator 404 is the phase current comparator for phase 1. A first input of comparator 404 is coupled to a current output terminal CSP₁ 430 which provides a signal proportional to the current being provided by phase 1. A second input of comparator 404 is coupled to the current limit threshold terminal OCL_THR 426. If the current being provided by phase 1 is higher than the current limit threshold OCL_THR 426, comparator 404 will provide a high signal at its output. Comparator 406 is the phase current comparator for phase N. A first input of comparator 406 is coupled to a current output terminal CSP_{N} 428 providing a signal proportional to the current being provided by phase N. A second input of comparator 404 is coupled to the current limit threshold terminal OCL_THR 426. If the current being provided by phase N is higher than the current limit threshold OCL_THR 426, comparator 406 will provide a high signal at its output.

OCL mode detection logic circuit 408 has N inputs and one output. Each of the N inputs is coupled to an output of a respective phase current comparator. The output of OCL mode detection logic circuit 408 provides a high or “true” signal if a certain number of its inputs are receiving a high signal, indicating that at least the certain number of phases are operating in current limit. The number of phases operating in current limit that are required to trigger a high at the output of OCL mode detection logic circuit 408 can be selected to be one, two, or any other number up to a maximum of N.

BM detection logic circuit 410 has a first input coupled to the output of comparator 402, and a second input coupled to the output of OCL mode detection logic circuit 408. BM detection logic circuit 410 combines the outputs of OCL mode detection logic circuit 408 and comparator 402 to determine whether the system should be operating in burst mode. If BM detection logic circuit 410 determines that the system should be operating in burst mode, it provides a signal at its output to begin linearly increasing the digital code that corresponds to the load line resistance R_{LL}.

Analog adder 412 has N inputs and one output. Each of the N inputs of analog adder 412 is coupled to the output of a respective current output terminal CSPx. Analog adder 412 sums all N of the respective phase current signals to calculate the total rail current signal, ISUM. Variable resistance circuit 414 has a first input coupled to the output of analog adder 412 that receives an analog signal. A second input of variable resistance circuit 414 is coupled to the output of BM detection logic circuit 410 and receives a digital binary number.

In at least one case, variable resistance circuit 414 is a digital-to-analog converter (DAC). However, variable resistance circuit 414 can be any circuit that provides a variable resistance in response to an input signal such as a digital binary number. In at least one case, variable resistance circuit 414 is an R-2R DAC. An R-2R DAC is a data converter that uses resistors to convert a digital binary number input into an analog output signal that is proportional to the value of the digital binary number. Resistor 434 is coupled between the output voltage terminal V_{OUT} 420 and the output of variable resistance circuit 414. The resistance provided by variable resistance circuit 414 sets the relative weighting of the ISUM signal. The resistance of resistor 434 sets the relative weighting of the signal at the output voltage terminal V_{OUT} 420. Together, variable resistance circuit 414 and resistor 434 set the load line resistance R_{LL}.

Integrator 416 has a first input coupled to a reference voltage terminal that provides a reference voltage VREF. A second input of integrator 416 is coupled to the output of variable resistance circuit 414 and to resistor 434. Capacitor 422 is coupled between the output of integrator 416 and the second input of integrator 416. Integrator 416 helps to ensure that the output voltage at output voltage terminal V_{OUT} 420 is regulated to the value VREF−(ISUM*R_{LL}), where R_{LL} is the load line resistance. The output of integrator 416 is the error voltage Vₑᵣᵣₒᵣ 432.

The output of integrator 416 is coupled to the input of duty cycle generator 418, which has N outputs, PWM₁ through PWM_{N}. Each of the respective outputs of duty cycle generator 418 is coupled to a respective power stage of the TLVR voltage converter. The duty cycle generator 418 modulates the N respective PWM signals to control the drive stages of each of the respective phases in response to the error voltage Vₑᵣᵣₒᵣ 432. Each of the respective outputs of duty cycle generator 418, PWM₁ through PWM_{N}, controls the power stage for its respective phase. Duty cycle generator 418 provides control signals to each of the respective phases in a phase-interleaved manner.

In this description, “terminal,” “node,” “interconnection,” “lead” and “pin” are used interchangeably. Unless specifically stated to the contrary, these terms generally mean an interconnection between or a terminus of a device element, a circuit element, an integrated circuit, a device, or other electronics or semiconductor component.

In this description, “ground” includes a chassis ground, an Earth ground, a floating ground, a virtual ground, a digital ground, a common ground and/or any other form of ground connection applicable to, or suitable for, the teachings of this description.

In this description, the term “couple” may cover connections, communications or signal paths that enable a functional relationship consistent with this description. For example, if device A generates a signal to control device B to perform an action, then: (a) in a first example, device A is coupled to device B by direct connection; or (b) in a second example, device A is coupled to device B through intervening component C if intervening component C does not alter the functional relationship between device A and device B, so device B is controlled by device A via the control signal generated by device A.

In this description, even if operations are described in a particular order, some operations may be optional, and the operations are not necessarily required to be performed in that particular order to achieve specified results. In some examples, multitasking and parallel processing may be advantageous. Moreover, a separation of various system components in the embodiments described above does not necessarily require such separation in all embodiments.

Modifications are possible in the described embodiments, and other embodiments are possible, within the scope of the claims.

1. A control circuit comprising:
a first comparator having first and second comparator inputs and a first comparator output, wherein the first comparator input is coupled to a first reference voltage source that provides a first threshold voltage, and the second comparator input is coupled to an output voltage terminal;
a second comparator having third and fourth comparator inputs and a second comparator output, wherein the third comparator input is coupled to a second reference voltage source that provides a second threshold voltage, and the fourth comparator input is coupled to a current output terminal;
a first logic circuit having N logic inputs and a first logic output, wherein a first logic input of the N logic inputs is coupled to the second comparator output, and the first logic circuit is configured to provide a true signal at the first logic output in response to a particular number of the N logic inputs receiving a respective true input;
a second logic circuit having first and second mode detection inputs and a mode detection output, wherein the first mode detection input is coupled to the first comparator output, and the second mode detection input is coupled to the first logic output;
a variable resistance circuit having first and second variable resistance inputs and a variable resistance output, wherein the first variable resistance input is coupled to the mode detection output;
an amplifier having first and second amplifier inputs and an amplifier output, wherein the first amplifier input is coupled to the variable resistance output, and the second amplifier input is coupled to a third reference voltage source that provides a reference voltage; and
a duty cycle generation circuit having a duty cycle input and N duty cycle outputs, wherein the duty cycle generation circuit is configured to provide a respective pulse width modulation (PWM) signal at each respective duty cycle output.

2. The control circuit of claim 1, wherein each respective duty cycle output is adapted to be coupled to a respective drive stage of a multiphase voltage converter.

3. The control circuit of claim 1, further comprising a resistor coupled between the output voltage terminal and the first amplifier input.

4. The control circuit of claim 3, wherein the current output terminal is a first current output terminal, and the control circuit is further comprising a third comparator having fifth and sixth comparator inputs and a third comparator output, wherein the fifth comparator input is coupled to the second reference voltage source, and the sixth comparator input is coupled to a second current output terminal, and the third comparator output is coupled to a second logic input of the first logic circuit.

5. The control circuit of claim 4, further comprising an adder circuit having N adder inputs and an adder output, wherein a first adder input is coupled to the first current output terminal, a second adder input is coupled to the second current output terminal, and the adder output is coupled to the second variable resistance input.

6. The control circuit of claim 1, wherein the variable resistance circuit is a digital-to-analog converter (DAC).

7. The control circuit of claim 2, wherein the duty cycle generation circuit provides respective control signals to each respective phase of the multiphase voltage converter in a phase-interleaved manner.

8. The control circuit of claim 1, further comprising a capacitor coupled between the amplifier output and the first amplifier input.

9. The control circuit of claim 2, wherein the first threshold voltage represents a voltage at the output voltage terminal for triggering a burst mode in which a current demand on the multiphase voltage converter is decreased.

10. The control circuit of claim 9, wherein the second threshold voltage represents a per-phase limit on each respective current output for triggering the multiphase voltage converter to enter the burst mode.

11. The control circuit of claim 10, wherein the multiphase voltage converter enters the burst mode responsive to the voltage at the output voltage terminal being below the first threshold voltage and a particular number of respective current outputs are above the second threshold voltage.

12. A voltage converter circuit comprising:
N power stage circuits, including a first power stage circuit and a second power stage circuit, wherein each power stage circuit includes a respective high-side transistor and a respective low-side transistor connected in series at a respective switching terminal; and
a controller circuit that includes:
a first comparator having first and second comparator inputs and a first comparator output, wherein the first comparator input is coupled to a first reference voltage source that provides a first threshold voltage, and the second comparator input is coupled to an output voltage terminal;
a second comparator having third and fourth comparator inputs and a second comparator output, wherein the third comparator input is coupled to a second reference voltage source that provides a second threshold voltage, and the fourth comparator input is coupled to a current output terminal;
a first logic circuit having N logic inputs and a first logic output, wherein a first logic input of the N logic inputs is coupled to the second comparator output, and the first logic circuit is configured to provide a true signal at the first logic output in response to a particular number of the N logic inputs receiving a respective true input;
a second logic circuit having first and second mode detection inputs and a mode detection output, wherein the first mode detection input is coupled to the first comparator output, and the second mode detection input is coupled to the first logic output;
a variable resistance circuit having first and second variable resistance inputs and a variable resistance output, wherein the first variable resistance input is coupled to the mode detection output;
an amplifier having first and second amplifier inputs and an amplifier output, wherein the first amplifier input is coupled to the variable resistance output, and the second amplifier input is coupled to a third reference voltage source that provides a reference voltage; and
a duty cycle generation circuit having a duty cycle input and N duty cycle outputs, wherein the duty cycle generation circuit is configured to provide a respective pulse width modulation (PWM) signal at each respective duty cycle output.

13. The voltage converter circuit of claim 12, wherein the voltage converter circuit is part of a multiphase voltage converter, and each respective duty cycle output is adapted to be coupled to a respective power stage circuit.

14. The voltage converter circuit of claim 12, wherein the controller circuit is further comprising a resistor coupled between the output voltage terminal and the first amplifier input.

15. The voltage converter circuit of claim 14, wherein the current output terminal is a first current output terminal, and the controller circuit is further comprising a third comparator having fifth and sixth comparator inputs and a third comparator output, wherein the fifth comparator input is coupled to the second reference voltage source, and the sixth comparator input is coupled to a second current output terminal, and the third comparator output is coupled to a second logic input of the first logic circuit.

16. The voltage converter circuit of claim 15, wherein the controller circuit is further comprising an adder circuit having N adder inputs and an adder output, in which a first adder input is coupled to the first current output terminal, a second adder input is coupled to the second current output terminal, and the adder output is coupled to the second variable resistance input.

17. The voltage converter circuit of claim 12, wherein the variable resistance circuit is a digital-to-analog converter (DAC).

18. The voltage converter circuit of claim 13, wherein the duty cycle generation circuit provides respective control signals to each respective phase of the multiphase voltage converter in a phase-interleaved manner.

19. The voltage converter circuit of claim 12, wherein the controller circuit is further comprising a capacitor coupled between the amplifier output and the first amplifier input.

20. The voltage converter circuit of claim 13, wherein the first threshold voltage represents a voltage at the output voltage terminal for triggering a burst mode in which a current demand on the multiphase voltage converter is decreased.

21. The voltage converter circuit of claim 20, wherein the second threshold voltage represents a per-phase limit on each respective current output for triggering the multiphase voltage converter to enter the burst mode.

22. The voltage converter circuit of claim 21, wherein the multiphase voltage converter enters the burst mode responsive to the voltage at the output voltage terminal being below the first threshold voltage and a particular number of respective current outputs are above the second threshold voltage.
